(19) United States
(12) Patent Application Publication
(10) Pub. No.: US 2005/0184479 A1
(43) Pub. Date: Aug. 25, 2005

(54) Mobile storage, transport and demonstration apparatus

(76) Inventor: Greg Moore, Temple, TX (US)

Correspondence Address: NATH & ASSOCIATES, 1030 15th STREET, NW, 6TH FLOOR, WASHINGTON, DC, 20005, US

(21) Appl. No.: 10/868,935

(22) Filed: Jun. 17, 2004

Related U.S. Application Data
(60) Provisional application No. 60/546,164, filed on Feb. 23, 2004.

(51) Int. Cl. B62B 3/00

(52) U.S. Cl. 280/47.34

(57) ABSTRACT

A mobile storage, transport and demonstration apparatus has a light-weight construction comprising first and second side walls in spaced apart relation with first and second face walls connected between the first and second side walls. The first and second side walls and the first and second face walls along with a bottom portion, mutually define a storage compartment having an open top. One of the walls has an access opening there-through. Another of the walls has a visual display surface carried thereon. A pair of wheels are connected to bottom ends of one of the side or face walls, with the wheels being mutually rotatable about an axis.

### FIELD OF THE INVENTION

The present invention relates to a mobile storage, transport and demonstration apparatus for objects, in particular that of athletic equipment, gear, and related materials, and which comprises at least one display or demonstration surface for presenting visual information.

### BACKGROUND

When training and participating in sports and sporting activities, it is common for many athletes, coaches, and trainers to have a need for a storage apparatus for the storage of objects, equipment, gear, and related materials required to train and participate in a particular sport or activity.

For example, long, shafted equipment such as hockey sticks, lacrosse sticks, baseball bats, and softball bats, can be awkward to carry. It is fatiguing and uncomfortable to carry long shafted equipment vertically, or unbalanced, for long distances such as from a locker room to an arena or playing field. Carrying equipment, such as those mentioned above, vertically or unbalanced locks a wrist in a flexed position, which over time can cause fatigue and is uncomfortable. If a player grasps the equipment away from their center of gravity, the player's wrist will flex away from a natural neutral position. Furthermore, the equipment's center of gravity concentrates the weight of the equipment on the flexed wrist, which additionally stresses the player's wrist. Carrying the equipment horizontally stresses the player's wrist less, however when carrying the equipment horizontally it can jut out in front and/or behind an individual thereby presenting a safety hazard to nearby persons and structures.

In order to open doors, walk through doorways, or down corridors to a locker room, arena, and/or playing field, the individual frequently must tip the equipment vertically, which can accidentally strike another individual or object causing injury or damage. Similarly, if doorways, corridors, or similar structures are crowded or blocked the individual must maneuver the equipment in an attempt to avoid striking another individual, or object. By placing the long equipment in a mobile storage apparatus many of these problems associated with individual stress, maneuverability, and accident can be avoided.

Similarly, quantities of regularly shaped, and irregularly shaped objects and equipment, such as balls, pads, gloves, mitts, hockey pucks, frisbees, etc. can be awkward to carry. For example, an individual seemingly has to do a combination of a balancing and juggling act when carrying several basketballs at once. Besides portability of this equipment in and of itself, there is also the consideration that when an individual is carrying such equipment their personal mobility and range of motion is quite restricted. This too, can easily lead to injury or accidentally cause injury or damage to another individual or object.

In an interscholastic or intramural environment, players may be required to carry objects and equipment along with any other requisite gear associated with their particular sport or activity. The individual's gear can comprise bulky additional objects and/or equipment, such as protective padding or guards, masks, gloves, head gear, uniforms, skates or shoes, pucks or balls, pine tar, glasses, scorebooks, etc. In colder weather or atmospheres, individuals may also struggle with heavy winter clothing, and additional gear over and above that which is normally required for the activity itself. Typically, an individual must carry all of this gear from the locker room to an arena and/or playing field often over long distances and in one trip.

In an attempt to remedy the above problems, personal storage and transport apparatuses have been created. Storage and transport apparatuses of the personal kind are meant only for individual use, and consist of a relatively small compartment into which the individual must try and fit all of the above-mentioned objects, equipment, and gear into. These personal storage and transport apparatuses have mainly consisted of a storage device of a size designed to be transported by an individual, and frequently do not allot the needed space for large quantities. Also, this can lead to wasting precious time during a sporting event or activity when an individual has to rummage through all of the objects, equipment, and gear compacted into the small compartment. Personal storage and transport apparatuses also only function as such, that is, being only a storage and transport device void of any other utility, which can lead to the need of further objects, equipment, and/or gear.

To remedy the problems of personal storage apparatuses, larger, more bulky apparatuses have also been created. One of the major flaws of these larger, more bulky storage apparatuses is that they are non-mobile, and are not meant, or are not readily able, to be used as a mobile storage apparatus. Even though these larger storage apparatuses have the ability to hold larger quantities of objects, since they are not readily mobile, this leaves an individual to remove the needed objects from the larger storage apparatus and manually bring them to a desired area. This can be accomplished in any number of ways, including that of using a smaller, personal storage apparatus as previously described. As a result, an individual will then encounter the same problems, if not more, associated with the previously mentioned personal storage apparatuses. Furthermore, many of these larger, more bulky, and non-mobile apparatuses have many of the same problems as the personal storage apparatuses.

It is also well known in the art, and to the layperson, that when training and participating in sports and other athletic activities it is common for many athletes, coaches, trainers, and individuals to have a need for a demonstration and display surface upon which visual information such as plans, strategies, set-ups, line-ups, play calling, etc. can be conveyed by illustrating the information on the demonstration and display surface. By illustrating these actions on the demonstration and display surface, it is possible to convey visual instructions with an accompanying audio presentation in a double re-enforcement manner.

Such demonstration and display surfaces in the past mainly consisted of paper, chalkboards, or dry-erase boards. These surfaces are either large, fixed devices, or small in order to accommodate easy portability and/or mobility. Although larger display surfaces are better for illustrating plans, strategies, set-ups, line-ups, play calling, etc. to an entire team or group of athletes, they are not readily portable and/or mobile.

In particular, larger marker board arrangements are extensively utilized in athletic and teaching environments, not only by individuals who find it convenient to work on such devices, but more particularly in training and competition situations where a marker board provides an extremely convenient tool for the visual presentation of information. In these situations, the ability to successfully convey information to a group of athletes or individuals is usually a key factor in the success of the team or group, since success can usually be attributed to the ability for the team or group to execute a desired strategy or play properly.

Such marker board arrangements traditionally employ a vertically enlarged marker board having an enlarged smooth white surface, defined by a conventional plastic resin or a similar material, to permit use with conventional erasable colored marker pens. The conventional marker board arrangements for interscholastic or intramural environments assume many different constructural shapes and configurations. Many such arrangements are portable, and often comprise a marker board associated with a foldable or collapsible frame to enable the arrangement to be moved about as desired. Arrangements of this type, however, generally consist primarily only of a marker board, and thus this not only limits flexibility of use in terms of the different types of visual information which can be displayed thereon, but also the assembly and transport of such arrangements is often complex and inconvenient. Further, such arrangements of this type do not provide adequate support or storage for visual display articles, or athletic, interscholastic, or intramural equipment.

### SUMMARY OF THE INVENTION

There is therefore a need for a mobile storage, transport and demonstration apparatus that is easily transportable, accommodates objects of wide-ranging geometry, and provides an easily viewed demonstration surface.

In order to over come the above deficiencies, the current invention remedies these and other problems by combining a large transportable/mobile storage apparatus for objects, equipment, gear and related materials, with a large display surface.

In a first preferred embodiment, a mobile storage, transport and demonstration apparatus has a light-weight construction comprising first and second side walls in spaced apart relation with first and second face walls connected between the first and second side walls. The first and second side walls and the first and second face walls along with a bottom portion, mutually define a storage compartment having an open top. One of the walls has an access opening there-through. Another of the walls has a visual display surface carried thereon. A pair of wheels are connected to bottom ends of one of the side or face walls, with the wheels being mutually rotatable about an axis.

Also, in the first preferred embodiment of a mobile storage, transport and demonstration apparatus, a visual display surface comprising one of a magnetic surface, dry-erase board, video or computer monitor, chalkboard, and easel-pad is carried by one of the side or face walls.

In a further preferred embodiment, a handle is connected to one of the face or side walls.

In another preferred embodiment of a mobile storage, transport and demonstration apparatus, one of the face or side walls comprises a grid, polymer, elastomer, net, fiber or fabric material. In a further preferred embodiment, the storage compartment comprises one of a bag, pouch, sack, and bin.

In another preferred embodiment, a bottom portion is disposed between the side walls and face walls. In a further preferred embodiment, at least one leg attached to the bottom end of either the side walls or face walls. In a further preferred embodiment, at least one wheel is pivotable about a vertical axis.

Also, in a further preferred embodiment, the apparatus is pivotable about a horizontal axis. In another preferred embodiment, the apparatus has a door, which can be a swing, vertical or horizontal slider, or flap type door, or can be made from bungee cords allowing for easy access to the storage compartment.

These and other aspects and features of the invention will be better understood with reference to the following figures and description wherein like numbers represent like objects throughout the several views.

### BRIEF DESCRIPTION OF THE FIGURES

FIG. 1 is a front elevational view of the preferred embodiment of the mobile storage, transport and demonstration apparatus with a first face wall with a visual display surface thereon.

FIG. 2 is a side elevational view of the preferred embodiment of the mobile storage, transport and demonstration apparatus.

FIG. 3A is a second side elevational view of the preferred embodiment of the mobile storage, transport and demonstration apparatus with an access door in the closed position.

FIG. 3B is a second side elevational view of the preferred embodiment of the mobile storage, transport and demonstration apparatus with an access door in the open position.

FIG. 4 is a rear elevational view of the preferred embodiment of the mobile storage, transport and demonstration apparatus with a second visual display surface thereon.

FIG. 5 is a top view of the preferred embodiment of the mobile storage, transport and demonstration apparatus.

### DETAILED DESCRIPTION OF THE PREFFERED EMBODIMENT

The present invention relates to a mobile storage, transport and demonstration apparatus for objects, in particular, equipment, gear, and related materials, for sports and activities and, which comprises at least one display surface for presenting visual information.

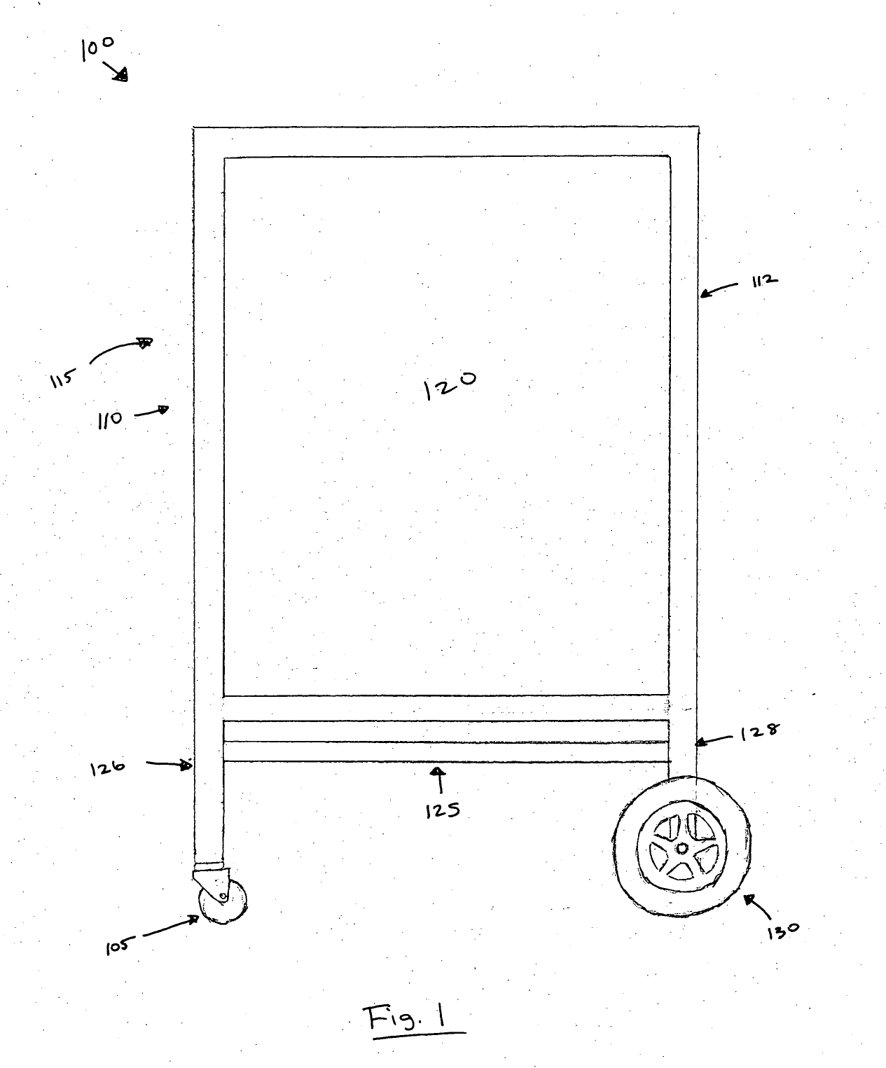

Referring now to FIG. 1, a front elevational view of a currently preferred embodiment of the mobile storage, transport and demonstration apparatus 100 is shown with a visual display surface on a first face wall side. As seen in FIG. 1, a first frame 110 defines a perimeter 112 of a first face wall 115 around apparatus 100. First face wall 115 carries a visual display surface 120.

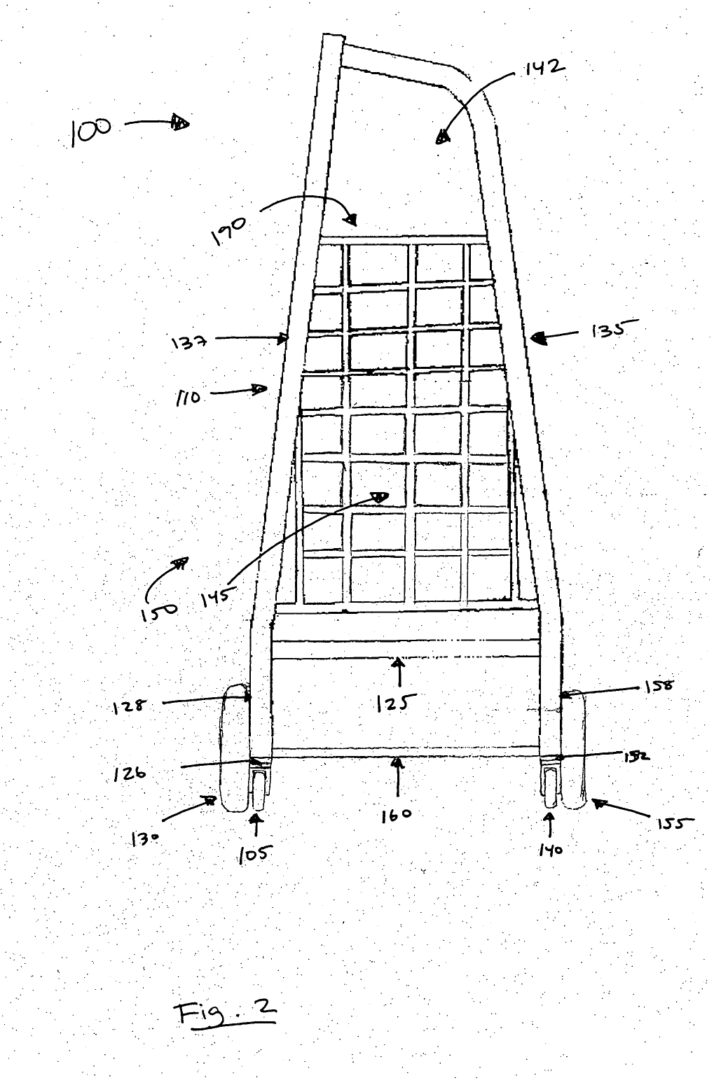

Referring now to FIG. 2, first frame 110 connects to second frame 135, to define perimeter 137 of a first side wall 150. Spaced between first frame 110 and second frame 135 is first side grid 145. First frame 110 and second frame 135 are connected in such a manner as to form an open top 142. Bottom portion 125 is spaced between depending ends 126, 128 of first frame 110 and depending ends 152, 158 of second frame 135, respectively. Depending ends 126 and 152 carry first guide wheel 105 and second guide wheel 140, respectively. Depending ends 128 and 158 carry first rear wheel 130 and second rear wheel 155 respectively, and are further connect by axle 160.

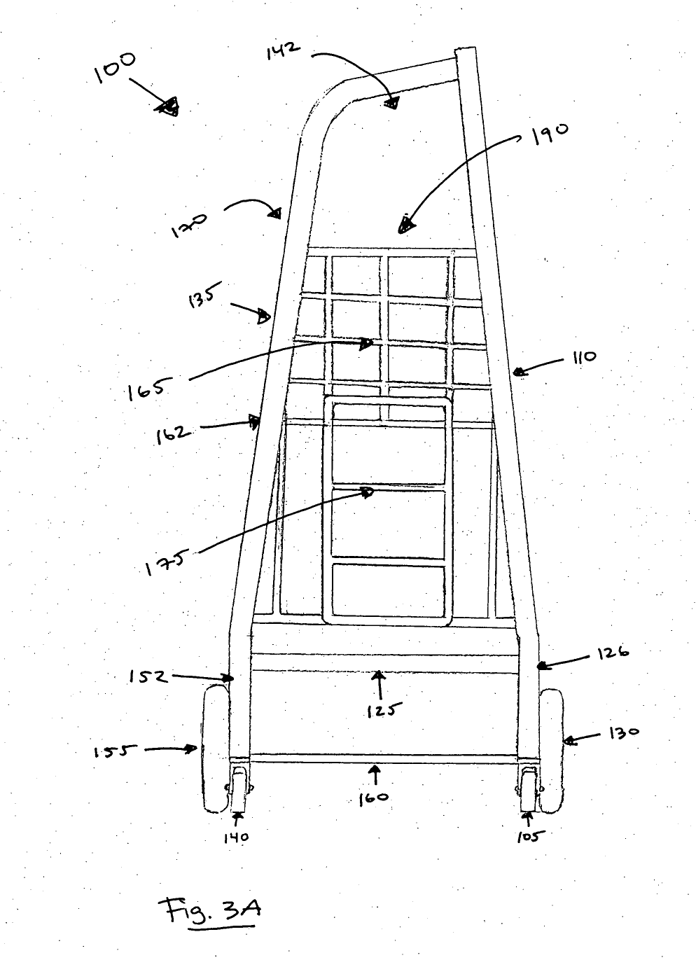

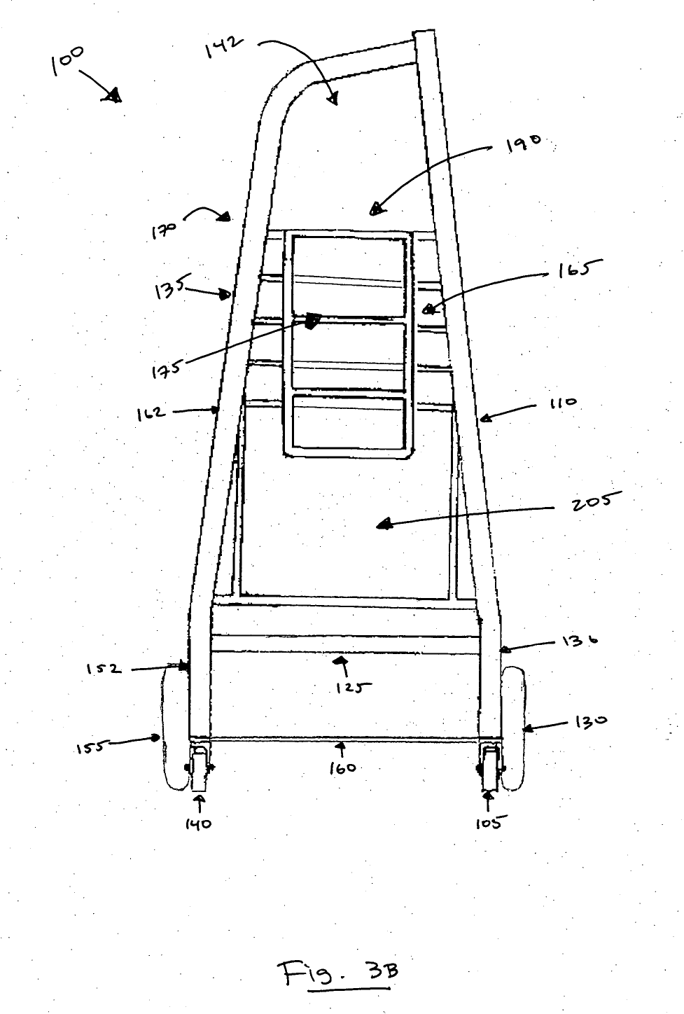

Referring now to FIGS. 3A and 3B, first frame 110 connects to second frame 135, to define perimeter 162 of a second side wall 170. Spaced between first frame 110 and second frame 135 is a second side grid 165 having an access opening 205 there-through. An operable door 175 is disposed over access opening 205.

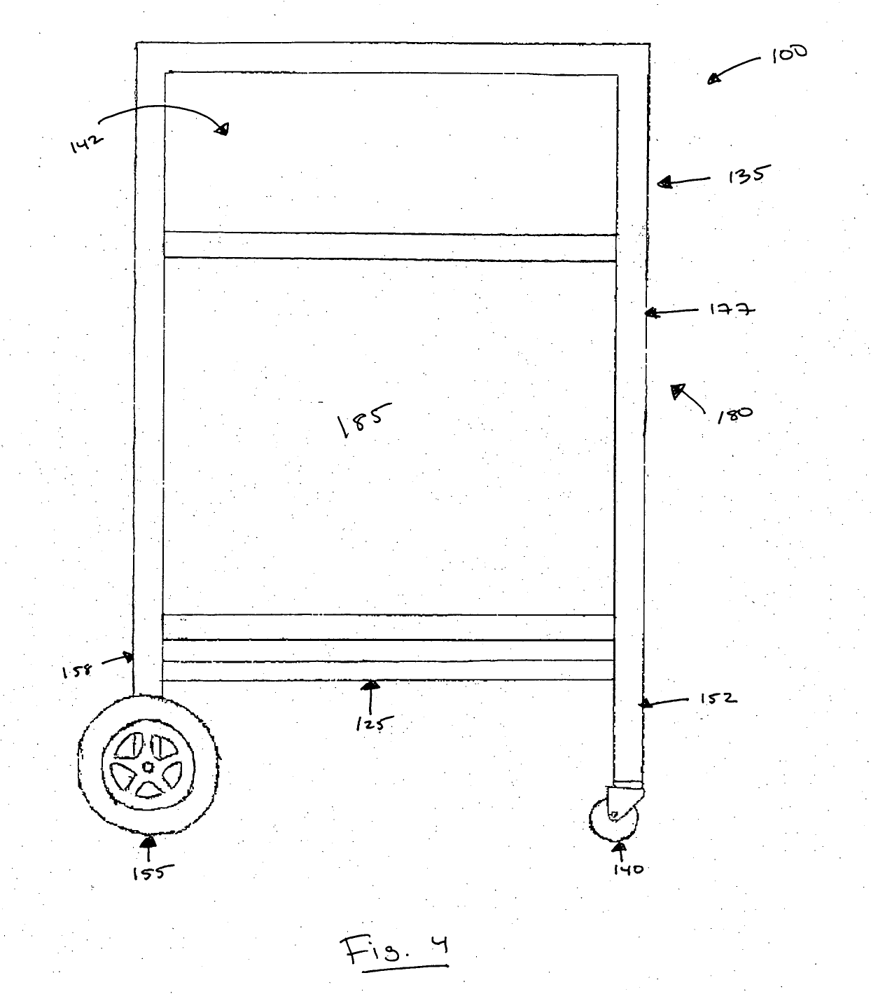

Referring now to FIG. 4, second frame 135 defines a perimeter 177 of a second face wall 180. Second face wall 180 carries a second visual display surface 185. Open top 142 is located above the second visual display surface 185.

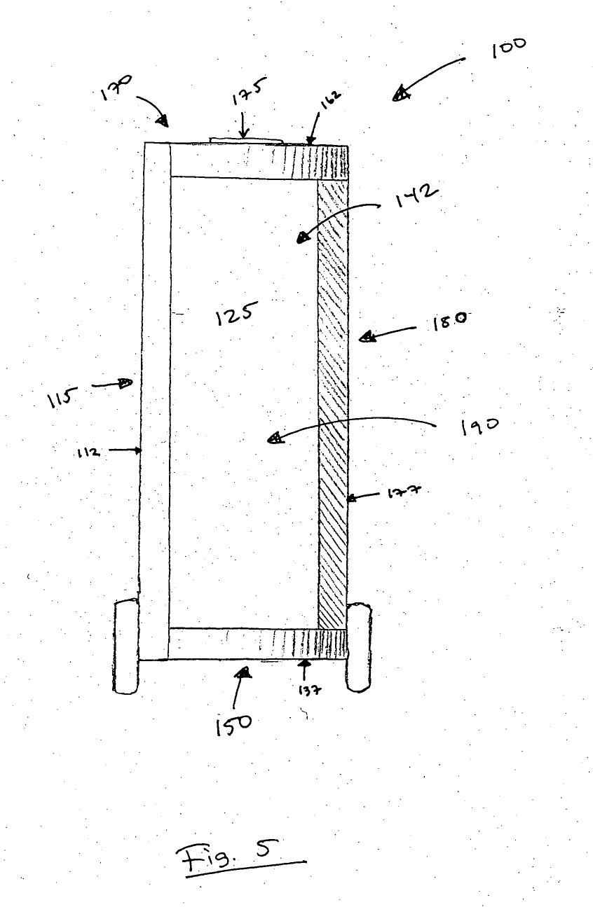

Referring now to FIG. 5, first face wall 115, first side wall 150, second side wall 170, second face wall 180, and bottom portion 125 collectively define a storage compartment 190 there-between. Perimeters 112, 137, 162, and 177 of first face wall, first side wall, second side wall, and second face wall respectively help define the outer most limits of storage compartment 190. Access to storage compartment 190 is provided through open top 142 and access opening 205. Access through opening 205 is regulated by door 175.

The above figures illustrate merely the preferred embodiment of a mobile storage, transport and demonstration apparatus. As one can imagine, there are many alternative embodiments which do not take away from the scope or spirit of the above-disclosed invention. Such alternative embodiments are listed below.

In an alternative embodiment of the mobile storage, transport and demonstration apparatus the visual display surface(s) can be, but need not be limited to, a dry-erase board, a blackboard, a chalk board, a wood board, a metal board, a cork board, a pad of paper, a television screen or computer monitor. The visual display surface(s) can be rigid or flexible, solid or non-solid, magnetic or non-magnetic, smooth or rough, permeable or non-permeable, clear, opaque, non-clear, transparent, non-transparent, or combination(s) thereof.

The visual display surface(s) can further be fixed or movable and can be attached to or incorporated into other features of the mobile storage, transport and demonstration apparatus, such as a wall, a top or a bottom or can be extraneous thereto.

Information can be displayed on the visual display surface, or surfaces, by and/or with any means, apparatus, method or process appropriate to the display surface, or surfaces used. For example an input of information can be displayed on the visual display surface such as a dry erase board, pad of paper, or chalk board, by use of a marker, pencil, or chalk. Similarly, if the visual display surface is a computer or television monitor the information can be input by a VCR, DVD, computer or interactive technology or technologies. It would be obvious to one skilled in the art and is within the scope of the disclosure to devise other means for similarly presenting information on the visual display surface.

In an alternative embodiment, the frame, walls, bottom portion and/or storage compartment can be defined by any conventional mesh, solid, and/or combination(s) of material(s) such as one or more metals, alloys, grids, plastics, polymers, fibers, nets, elastomers, fabrics, fibers, wood, and any other common material and combinations thereof. It would be within the scope of this disclosure for the storage compartment to be compartmentalized or non-compartmentalized, with such devices as fixed or fold-down shelves, separation walls, racks, bins, pouches, bags, and/or sacks. Further, the storage compartment can have an accessory compartment or compartments.

Ideally, the mobile storage, transport and demonstration apparatus is constructed from a relatively light-weight material, wherein light-weight is defined as the total tare weight of the mobile storage, transport and demonstration apparatus weighing less than about 250 pounds. However, in an alternative embodiment, the mobile storage, transport and demonstration apparatus can be constructed of a non-light-weight material. Non-light-weight material is defined as the total tare weight of the mobile storage, transport and demonstration apparatus weighing more than about 250 pounds.

The frames that define the mobile storage, transport and demonstration apparatus can be of any utilizable geometric shape or size, and constructed in a singular or a multi-part construction joined conventionally. In an alternate embodiment the storage compartment of the mobile storage, transport and demonstration apparatus can be defined by a frame or can be frameless, such as injection molded or extruded producing only face walls and side walls to which a visual display surface and wheels can be connected.

In another alternative embodiment, the mobile storage, transport and demonstration apparatus can further include a handle or push/pull mechanism to allow for ease of mobility and transportability. Further, for easier mobility and transportability, the mobile storage, transport and demonstration apparatus is preferably pivotable about a substantially vertical axis. In an alternative embodiment the mobile storage, transport and demonstration apparatus can include a footstep, or similar feature, to allow the mobile storage, transport and demonstration apparatus to easily be pivotable about a substantially horizontal axis. However, in an alternative embodiment the mobile storage, transport and demonstration apparatus can be pivotable about more than one axis.

In a further alternate embodiment a predefined template or outline of any given sporting or activity field and/or arena can be pre-applied or overlaid on the display surface, or surfaces. The predefined outline can be large or small relative to the visual display surface, or surfaces and can comprise a magnetic layer, a transparent overlay, a clear coated layer, a temporary write-able surface, a color coated portion, and combinations thereof. The predefined outline(s) can be removably attached to the visual display surface, or surfaces or can be permanently attached. In the case of a computer or television monitor, a windowed layer can be superimposed by a computer over or under the information presented.

The wheels utilized in the mobile storage, transfer and demonstration apparatus can be rotatable about an axis or axes. Preferably, the wheels will be rotatable about a horizontal axis relative to the face walls and side walls. Further, at least one wheel can be pivotable about a vertical axis relative to the face walls and side walls. Another alternate embodiment includes the use of a fixed or foldable leg or legs in place of, or in conjunction with, the front and/or rear guide wheels.

The mobile storage, transport and demonstration apparatus can further include a top that covers the storage compartment in part or full. The top can similarly be rigid or flexible, magnetic or non-magnetic, smooth or rough, permeable or non-permeable, clear, opaque, non-clear, transparent, non-transparent, or combination(s) thereof and can be fixed or moveable. Further, the top can be defined by any conventional mesh, solid, and/or combination(s) of material(s) such as one or more metals, alloys, grids, plastics, polymers, fibers, nets, elastomers, fabrics, fibers, wood, and any other common material and combinations thereof. The top can be attached to the apparatus by a hinge, hinges, or similar device, or can be completely removable.

In the preferred embodiment, the mobile storage, transport and demonstration apparatus has a door, which can allow an athlete or individual access the storage compartment. The door can be any conventional type door such as, but not limited to, a side-swing door, tilt-up door, pull-up door, tilt down door, flap, or slider door. Further, the door can be constructed from metals, alloys, grids, plastics, polymers, fibers, nets, elastomers, fabrics, fibers, wood, and any other common material and combinations thereof. The door can be any relative size to the wall in which it is located, and in an alternative embodiment, the door can be the wall of the mobile storage, transport and demonstration apparatus.

In a further alternative embodiment, the mobile storage, transport and demonstration apparatus can have more than one door. Also, it is envisioned that the door be constructed of a elastomeric material such as a bungee cord or similar material to allow an athlete or individual to access the storage compartment by manipulating the at-rest configuration state of the door to an expanded configuration state for removing objects from the storage compartment. After the athlete or individual has removed an object or objects from the storage compartment the elastomeric material can then constrict and the door can return from the expanded configuration state back to the at-rest configuration state.

The present invention has been described with respect to preferred selected embodiments, and possible alternative embodiments thereof. However, other embodiments would be obvious to those skilled in the art without departing from the spirit and scope of the appended claims.

1. A light-weight mobile storage, transport and demonstration apparatus comprising:
first and second side walls in spaced apart relation;
first and second face walls connected between said first and second side walls, said first and second side walls and said first and second face walls mutually defining a storage compartment there between having an open top;
one of said walls having an access opening there-through, another of said walls comprising a visual display surface;
a pair of wheels connected to bottom ends of one of said side or face walls, said wheels being rotatable about an axis.

2. A mobile storage, transport and demonstration apparatus according to claim 1, said visual display surface comprising one of a magnetic surface, dry-erase board, video or computer monitor, and chalkboard.

3. A mobile storage, transport and demonstration apparatus according to claim 1, further comprising a handle connected to one of said face or side walls.

4. A mobile storage, transport and demonstration apparatus according to claim 1, wherein one of said face or side walls comprises a grid, polymer, elastomer, net, fiber or fabric material.

5. A mobile storage, transport and demonstration apparatus according to claim 1, said storage compartment comprises one of a bag, pouch, sack, and bin.

6. A mobile storage, transport and demonstration apparatus according to claim 1, said storage compartment further comprising a bottom portion disposed between said side walls and face walls.

7. A mobile storage, transport and demonstration apparatus according to claim 1, said mobile storage, transport and demonstration apparatus having at least one leg attached to said bottom end of either said side walls or face walls.

8. A mobile storage, transport and demonstration apparatus according to claim 1, said mobile storage, transport and demonstration apparatus having at least one wheel pivotable about a vertical axis.

9. A mobile storage, transport and demonstration apparatus according to claim 1, said mobile storage, transport and demonstration apparatus pivotable about an axis.

10. A mobile storage, transport and demonstration apparatus according to claim 1, said mobile storage, transport and demonstration apparatus having a door.

11. A mobile storage, transport and demonstration apparatus according to claim 1, said door comprising a swing, vertical, horizontal, or flap type.

12. A mobile storage, transport and demonstration apparatus according to claim 1, said door comprising bungee cords.

13. A method of training athletes, comprising:
providing a mobile storage, transport and demonstration apparatus comprising a storage compartment further comprising at least one visual display surface connected thereto;
graphically demonstrating a play, strategy, or instructions on said visual display surface;
dispensing equipment from the storage compartment for the play, strategy, or instructions;

14. A method according to claim 13, further comprising
attaching a predefined outline on at least one said visual display surface.

15. A method for manufacturing a mobile storage, transport and demonstration apparatus comprising:
providing a storage compartment having at least one wall;
providing at least one visual display surface;
connecting at least one said visual display surface to at least one said wall such that at least one said visual display surface is visible;
connecting at least one wheel to said wall.

16. A light-weight mobile storage, transport and demonstration apparatus comprising:
a bottom portion;
first and second side walls in spaced apart relation;
first and second face walls connected between said first and second side walls, said first and second side walls and said first and second face walls in conjunction with said bottom portion mutually defining a storage compartment having an open top;
one of said walls having an access opening there-through, another of said walls comprising a visual display surface;
wherein first and second side and face walls are connected by at least one frame and a pair of wheels connected to bottom ends of said frame; said wheels being rotatable about an axis; said access opening being a slider door; and said visual display surface being a dry erase board.
